(19) United States
(12) Patent Application Publication
(10) Pub. No.: US 2022/0198530 A1
(43) Pub. Date: Jun. 23, 2022

(54) SELECTION CRITERIA FOR THIRD PARTY TASK EXECUTION

(71) Applicant: Wells Fargo Bank, N.A., San Francisco, CA (US)

(72) Inventors: Darron D. Lockett, Mint Hill, NC (US); Michael Ian Goldsmith, Cornelius, NC (US); Amin El Qadi, Waxhaw, NC (US); Colleen Ann Cody, Jacksonville, FL (US); Navin Chhablani, Concord, NC (US); Shaun S. Elhoss, Allen, TX (US); Eric Cleve Williamson, Highlands Ranch, CO (US); David Schiffmayer, Evergreen, CO (US)

(21) Appl. No.: 15/698,250

(22) Filed: Sep. 7, 2017

(51) Int. Cl. G06Q 30/02; G06Q 10/06; G06Q 30/06

(52) U.S. Cl. CPC G06Q 30/0282; G06Q 30/0613; G06Q 10/0639

(57) ABSTRACT

A method implemented on an electronic computing device includes obtaining a ranking order for each vendor. The ranking order is based at least in part on a performance evaluation of each vendor. An allocation percentage is obtained for each vendor based on the ranking. The allocation percentage corresponds to a number of requests for the appraisal that can be assigned to each vendor. Vendors are assigned to perform the appraisal based on the allocation percentage for the vendor. The vendors are assigned in either a static, repeatable sequence or in a dynamic evaluation of open appraisal orders for each vendor.

### BACKGROUND

Processes used in businesses and other organizations can include a plurality of tasks that may need to be completed in a sequential order. For example, during the manufacture of a product, raw materials may need to be machined into small parts before the small parts can assembled with other parts. As another example, during the construction of a home, the foundation of the home needs to be built before rooms, plumbing and electrical work can be done. When tasks need to be completed in a sequence, a bottleneck in any one task can cause a delay in the completion of the overall process.

### SUMMARY

Embodiments of the disclosure are directed to a method implemented on an electronic computing device for allocating vendors for performing an appraisal associated with the purchase of a home. The method comprises: obtaining a ranking order for each vendor, the ranking order based at least in part on a performance evaluation of each vendor; obtaining an allocation percentage for each vendor based on the ranking, the allocation percentage corresponding to a number of requests for the appraisal that can be assigned to each respective vendor; and assigning vendors to perform the appraisal based on the allocation percentage for the vendor, the vendors being assigned in either a static, repeatable sequence or in a dynamic evaluation of open appraisal orders for each vendor.

In another aspect, a method implemented on an electronic computing device for allocating vendors for performing an appraisal of a home comprises: receiving a request for a home appraisal; determining a current number of appraisals currently being processed by each vendor; determining a current percentage of appraisals currently being processed for each vendor; determining a target percentage of appraisals for each vendor; calculating for each vendor a percentage deviation between the current percentage of appraisals currently being processed for each respective vendor and the target percentage of appraisals for each respective vendor; identifying vendors for which the current percentage of appraisals for a vendor is less than the target percentage of appraisals for the vendor; and assigning the request to a vendor having the highest percentage deviation among the vendors for which the current percentage of appraisals for the vendor is less than the target percentage of appraisals for the vendor.

In yet another aspect, an electronic computing device comprises: a processing unit; and system memory, the system memory including instructions which, when executed by the processor, cause the electronic computing device to: determine or utilize a ranking order for vendors used to perform home appraisals, the ranking order based at least in part on a performance evaluation of each vendor; determine or utilize a target allocation percentage for each vendor based on the ranking, the target allocation percentage representing a target for a percentage of home appraisals to be allocated to the each vendor; determine a number of home appraisals currently being processed by each vendor; calculate a current percentage of home appraisals currently being processed by each vendor, the current percentage for the each vendor being equal to the number of home appraisals currently being processed by each respective vendor divided by the total number of home appraisals currently being processed for all vendors; calculate a percentage deviation between the current percentage of home appraisals being processed by each vendor and the target allocation percentage of appraisals for each respective vendor, the percentage deviation for a vendor being equal to the current percentage of home appraisals currently being processed by the vendor subtracted from the target allocation percentage from the vendor; receive a request for a home appraisal; identify a vendor having a highest positive number for the percentage deviation between the current percentage of home appraisals being processed by the vendor and the target allocation percentage for the vendor; when a single vendor is identified having the highest positive number for the percentage deviation, assign the request for the home appraisal to the single vendor; and when two or more vendors have the highest positive number for the percentage deviation: identify the ranking order for the two or more vendors; and assign the request for the home appraisal to the one of the two or more vendors having the higher ranking order.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports an optimal selection of home appraisal vendors.

FIG. 2 shows example modules of the vendor selection engine of FIG. 1.

FIG. 3 shows an example table that illustrates a fixed, repeating sequence of vendor allocation for appraisals.

FIG. 4 shows an example vendor allocation sequence.

FIG. 5 shows an example method for a fixed, repeating sequence for assigning vendors for appraisals.

FIG. 6 shows additional details of an example operation of the method of FIG. 5.

FIG. 7 shows an example method for a dynamic performance evaluation for assigning vendors for appraisals.

FIG. 8 shows an example table containing data for a sequence of a dynamic performance evaluation method for allocating vendors for appraisals.

FIG. 9 shows another example table containing data for the sequence of the dynamic performance evaluation method.

FIG. 10 shows yet another example table containing data for the sequence of the dynamic performance evaluation method.

FIG. 11 shows yet another example table containing data for the sequence of the dynamic performance evaluation method.

FIG. 12 shows yet another example table containing data for the sequence of the dynamic performance evaluation method.

FIG. 13 shows yet another example table containing data for the sequence of the dynamic performance evaluation method.

FIG. 14 shows example physical components of the organization server computing device of the system of FIG. 1.

### DETAILED DESCRIPTION

The present disclosure is directed to systems and methods for optimizing execution of a task that is part of a sequence and that can be performed by a plurality of third party sources. By determining an optimal selection of the third party sources, the system and methods can minimize bottlenecks in the task and permit the task to be completed in an efficient manner.

In this disclosure, the third party sources are known as vendors. Implementing an optimal selection of vendors can comprise controlling which vendors are selected for the task and how often a specific vendor is used in an execution of the task.

In one embodiment used in this disclosure, an example task is a home appraisal for a mortgage. During a mortgage application process, the home for which the mortgage is being obtained is typically appraised in value. A financial institution, such as a bank or mortgage company, can select one of a plurality of available vendors to conduct the appraisal. An example vendor can be a company that specializes in or has an expertise in home appraisals. Each vendor can be rated based on such factors as quality of work, and performance criteria (e.g., turnaround time, on time delivery, responsiveness, regulatory compliance, etc.). A final performance score can be assigned to each vendor. Selection of a vendor can be based on the final performance score and other factors, as discussed later herein. Although, a home appraisal task is discussed herein, the systems and methods can also be applied to other tasks. For example, the systems and methods can be used during the manufacture of an item when a plurality of vendors is used in the manufacture of an item—for example to provide parts for the manufacture of an automobile or to provide electronic components for the manufacture of an electronic computer.

In this disclosure, two different methods are described for assigning vendors for a home appraisal. A first method assigns vendors in a fixed, repeating sequence based on the performance scores of the vendors. Using the first method, vendors with high relative performance scores are selected more in the fixed, repeating sequence than vendors with low relative performance scores. A second method assigns vendors based on a dynamic performance evaluation of the vendors. The dynamic performance evaluation of the vendors comprises a dynamic evaluation of each vendor's relative capacity.

The systems and methods can implement logic known as Little's Law, which can provide a mathematical relationship for an average turnaround time (TAT) in a system, an amount of work in progress in the system and a completion rate of the system. Based on Little's Law, TAT can deteriorate when 1) processes become slower (e.g. completion rate decreases), 2) the number of open orders (work in progress) decreases and 3) a combination of 1) and 2). Using the systems and methods, the number of open orders in the system can be controlled to maintain a consistent TAT for the system.

The systems and methods disclosed herein are directed to a computer technology that can automatically determine which vendors should be selected to appraise real estate for lending or non-lending purposes, so that multiple appraisal requests can be assigned in an efficient manner. As a result of using the systems and methods, bottlenecks in the appraisal process can be minimized, queuing time for appraisals can be reduced, processing time for completing mortgage applications for a plurality of customers can be reduced and appraisal service across a broad spectrum of customers can be improved. In addition, computer efficiencies can be enhanced due to the reduced queuing time and an efficient process flow.

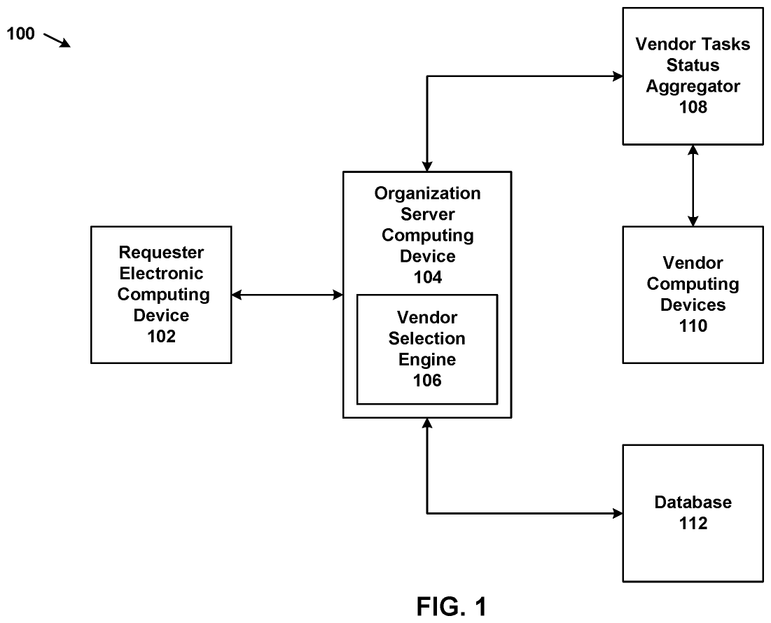

FIG. 1 shows an example system 100 that can support an optimal selection of home appraisal vendors. System 100 includes a requester electronic computing device 102, an organization server computing device 104, a vendor tasks status aggregator 108, vendor computing devices 110 and a database 112. The organization server computing device 104 includes a vendor selection engine 106. More, fewer or different computers and modules are possible.

The example requester electronic computing device 102 is an electronic computing device of an individual who is requesting a home appraisal. The individual can be an employee of an organization, such as a bank or a mortgage company that can provide mortgages to customers of the bank or mortgage company. The electronic computing device is typically a desktop or laptop computer, but can also be other types of computing devices, such as a tablet computer or smartphone. The individual can be requesting the home appraisal for the customer as part of the mortgage application process.

The example organization server computing device 104 is a server computing device of the organization, such as the bank or mortgage company, that supports the delivery of mortgages to the customers of the bank or mortgage company. Organization server computing device 104 can store or access information regarding the customer who is applying for the mortgage, information regarding the home being purchased and information regarding vendors who can appraise the home. In some implementations, organization server computing device 104 can comprise an electronic computing device other than a server computing device.

The example vendor selection engine 106 manages a selection of vendors for home appraisals. A vendor can be a third party company or individual with an expertise in home appraisals that is selected by the organization to conduct the appraisal. The vendor selection can comprise determining a performance score or utilizing an externally determined performance score for each vendor and assigning a vendor based on the performance score and based on a method of vendor allocation being used. As described herein, one method of vendor allocation comprises use of a fixed sequence of vendors, and a second method comprises assigning vendors based on a dynamic evaluation of the vendors' relative capacity.

The example vendor tasks status aggregator 108 compiles performance data for each vendor used by the organization for the home appraisals. The performance data can include an historical performance score for the vendor and a dynamic performance status of the vendor. The historical performance score can comprise data regarding quality of home appraisals for the vendor and a time for completion of the home appraisals by the vendor. The dynamic performance status can comprise status data for current home appraisals being performed by the vendor. The status data can include data regarding a number of properties currently being appraised by the vendor, when the home appraisals were initiated and a home appraisal capacity for the vendor. As discussed in more detail later herein, the home appraisal capacity can include a maximum number of homes permitted to be appraised by the vendor and a current number of homes being appraised by the vendor over a specified period of time.

The example vendor computing devices 110 comprise server and other computer systems used by the vendor during home appraisals. The vendor computing devices 110 can provide status as to the home appraisals currently being processed by the vendor.

The example database 112 is a database associated with the organization. Information regarding customers, properties, mortgages and vendors can be stored in database 112. Database 112 can be distributed over a plurality of databases. The vendor selection engine 106 can be programmed to query (e.g. using SQL) database 112 to obtain vendor information. Other modules on organization server computing device 104 can query database 112 to obtain customer, mortgage and home information. Various customer, mortgage, home and vendor information can be stored in and retrieved from database 112.

An example database schema for a vendor is shown below:
vendor_id
vendor_quality_rating
vendor_average_time_for_appraisal_completion
vendor_percentage_of_time_within_contract_SLAs
vendor_performance_score

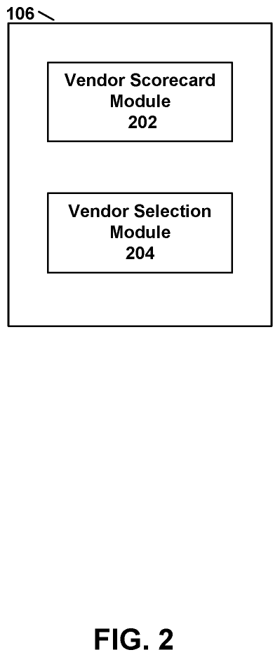

FIG. 2 shows example modules of vendor selection engine 106. The vendor selection engine 106 includes a vendor scorecard module 202 and a vendor selection module 204. More, fewer, or different modules are possible.

The example vendor scorecard module 202 can evaluate home appraisal data from vendors and compile a performance score for each vendor. An example algorithm for calculating a performance score for a vendor can be:

performance score=(service score*weighting for service)+(quality score*weighting for quality)

where,
service score is based on the vendor percentage of time within contract SLA,
quality score is a normalized representation of vendor quality,
weighting for service is a weighting percentage for the service score,
weighting for quality is a weighting percentage for the quality score

As used in the above equation and database schema, the vendor percentage of time within contract SLA represents a percentage of time in which a vendor meets the terms of contracted service level agreement (SLA). For example, when a contract SLA for a vendor calls for a vendor to complete appraisal orders within 10 days and, for 100 appraisal orders completed by the vendor, 10 were completed in more than 10 days and 90 were completed within 10 days, the vendor percentage of time within SLA for the vendor would be 90% (90/100), indicating that 90% of the orders were completed within the contracted time period in the SLA.

As used in the above equation, the service score is a number that is based on the vendor percentage of time within the contract SLA for the vendor. Table 1 below shows an example service score determination table indicating how a service score can be determined from a vendor percentage of time within contract SLA (% SLA) for the vendor.

TABLE 1

| | Service |
|---|---|
| % SLA | Score |
| 95+ | 100 |
| 90-95 | 90 |
| 80-90 | 80 |
| 70-80 | 60 |
| Less than 70 | 40 |

As shown in Table 1, when the % SLA is 95 or more, the service score is 100, when the % SLA is 90-95, the service score is 90, when the % SLA is 80-90, the service score is 80, when the % SLA is 70-80, the service score is 60 and when the % SLA is less than 70, the service score is 40. Other examples are possible.

As used in the above equation, the quality score for a vendor is a normalized score based on a raw quality score for the vendor. In an example implementation, the raw quality scores for vendors can range from 1 to 10 and the normalized quality scores for the vendor can range from 10 to 100. For example, if the raw quality score is 9 for a vendor, the normalized quality score is 9/10 or 90.

As used in the above equation, the weighting for service and the weighting for quality are weighting percentages applied to the service score and the normalized quality score, respectively. The total of the weighting for service and the weighting for quality always equals 100%.

In an example calculation of a performance score for a vendor based on a service score of 100, a quality score of 90, a weighting for service of 50% and a weighting for quality of 50%, the performance score equals 95, corresponding to (100*0.5)+(90*0.5)=50+45=95.

The vendor scorecard module 202 can also calculate a positional rank among vendors based on the performance scores of the vendors. A vendor having the highest performance score is assigned a positional rank of 1, a vendor having the next highest performance score is assigned a positional rank of 2, etc. In an example implementation, when two vendors have the same performance score, the vendor with the highest quality score receives the higher positional rank.

The vendor scorecard module 202 can also calculate an allocation percentage for appraisal orders among vendors based on a positional rank of performance scores for the vendors. The allocation percentage represents a percentage of incoming appraisal orders that are designated to be allocated to a particular vendor. In addition, a correlation between allocation percentage and positional rank can be different for different markets, for example for appraisals performed in different cities. For example, for an appraisal order system having five vendors, for one city (for example Dallas, Tex.), allocation percentages for the five vendors can be 40%, 30%, 15%, 10% and 5% respectively, corresponding to positional rankings 1-5. For another city (for example Chicago, Ill.), the allocation percentages can be 60%, 25%, 10%, 5% and 0% for the same positional rankings 1-5. The correlation between allocation percentage and positional rank can also be different for different counties, states, Metropolitan Statistical Areas (MSAs), zip codes or other defined geographical area in which a vendor is located.

In some implementations, one or more of the performance scores, positional rankings and allocation percentages can be provided to vendor selection engine 106 from one or more electronic computing devices external to organization server computing device 104 (not shown in FIG. 1). For one or more of these implementations, vendor scorecard module 202 may not be included in vendor selection engine 106. Instead, functionality for vendor scorecard module 202 can be included on one or more of the external electronic computing devices.

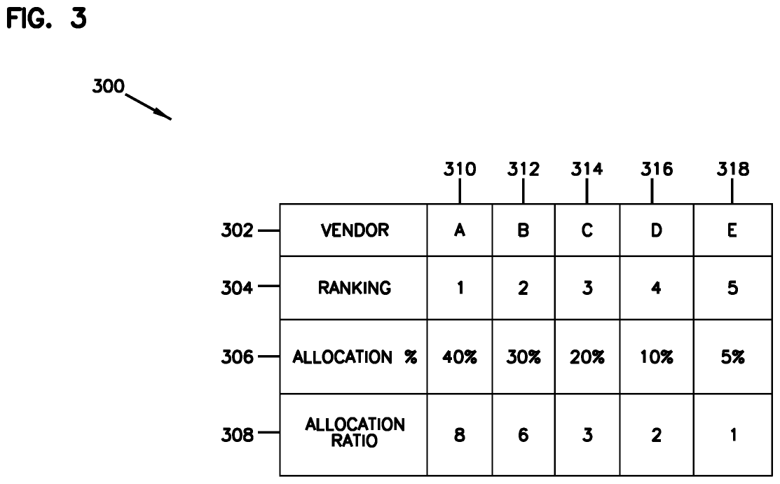

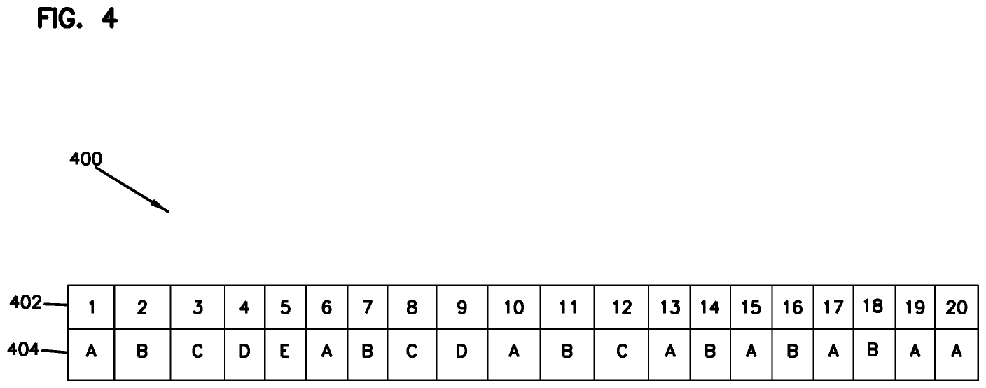

The example vendor selection module 204 includes functionality for selecting vendors for appraisals. In one example implementation, the vendor selection module 204 can implement the first method of assigning vendors for appraisals, discussed earlier herein, of assigning vendors to appraisals using a fixed repeating sequence method based on vendor performance scores. The fixed repeating sequence is implemented using Heijunka, a leveling method that is used to assign vendors with high performance scores in the fixed repeating sequence more often than vendors with low performance scores. A detailed example of how the vendor selection module 204 implements the fixed repeating sequence method is provided later herein with reference to FIGS. 3-4.

In another example implementation, vendor selection module 204 can implement the second method of assigning vendors for appraisals, discussed earlier herein, of assigning vendors to appraisals based on a dynamic performance evaluation of the vendors' relative capacity. The dynamic performance evaluation can comprise evaluating a percent of open orders (or work in progress) for each vendor. The percent of open orders can be compared to a target allocation percentage for the vendor. Each new incoming order is assigned to a vendor having a greatest percentage variance to the target allocation percentage for the vendor. Because the percent of open orders dynamically changes based on orders completed, cancelled and new orders received for the vendor, the percentage variance to the target allocation dynamically changes for the vendor.

By using the dynamic performance evaluation, the vendor selection module 204 can ensure each individual appraisal transaction is assigned to the vendor with the most available relative capacity at the time the appraisal is requested; where the best performing vendors have the largest set amount of available capacity ensuring the majority of volume is concentrated with the best performing vendors. A detailed example of how the vendor selection module 204 uses the dynamic performance evaluation is provided later herein.

There can be various technical advantages associated with the systems and method described herein. For example, organization server computing device 104 can be optimized to process mortgage applications so that waiting time for the appraisal task in the mortgage application process can be minimized. In this way, organization server computing device 104 can process mortgage applications more efficiently than if the appraisal task were implemented in a less optimized manner. This can result in an overall system that is faster, uses less computing power and/or is able to handle an increased number of mortgage applications.

FIG. 3 shows an example table 300 that illustrates vendor allocations using the fixed, repeating sequence method of vendor allocation for appraisals. Table 300 includes rows for vendor 302, ranking 304, allocation percentage 306 and allocation ratios 308. Table 300 also includes columns for five vendors—vendor A 310, vendor B 312, vendor C 314, vendor D 316 and vendor E 318 but is not limited to only 5 vendors. Any number of vendors can be used.

The ranking 304 corresponds to the positional ranking of a vendor discussed earlier herein. The allocation percentage 306 represents a percentage of orders to be allocated to a particular vendor in the fixed, repeating sequence. As discussed earlier herein, the allocation percentage 306 is correlated with the performance ranking. The allocation ratios 308 represent an actual number of appraisals allocated to a vendor in the fixed repeating sequence. The allocation ratios 308 are based on the allocation percentage 306 for a vendor and the volume of appraisal orders in the fixed, repeating sequence.

For the example table 300, there are five vendors used for appraisals and the fixed, repeating sequence has a total of 20 appraisals. Because vendor A 310 has an allocation percentage of 40%, vendor A 310 receives 40% of 20 or 8 appraisals for each fixed repeating sequence. Similarly, vendor B 312 receives 30% of 20 or 6 appraisals, vendor C 314 receives 15% of 20 or 3 appraisals, vendor D 316 receives 10% of 20 or 2 appraisals and vendor E 318 receives 5% of 20 or 1 appraisal.

FIG. 4 shows an example vendor allocation sequence 400 based on table 300. The vendor allocation sequence 400 includes an appraisal number 402 ranging from 1 to 20 and a vendor identifier 404. The vendor allocation sequence 400 includes a sequence of 20 appraisals. In the sequence of 20 appraisals, per the allocation ratios discussed above, vendor A 310 is used 8 times, vendor B 312 is used 6 times, vendor C 314 is used 3 times, vendor D 316 is used 2 times and vendor E 318 is used once.

The vendor allocation sequence 400 comprises each vendor being used once (appraisals 1-5), followed by vendors A-D (appraisals 6-9), followed by vendors A-C (appraisals 10-12), followed by vendors A-B three times (appraisals, 13-14, 15-16 and 17-18) followed by appraisals A twice (19 and 20). This sequence of vendor allocation is repeated, irrespective of any possible performance degradation for any of the vendors. However, the performance scores of vendors can be revised periodically, for example weekly or monthly, based on updated information for the vendors. When the performance scores are revised, the sequence of vendor allocation can change based on the revised performance scores.

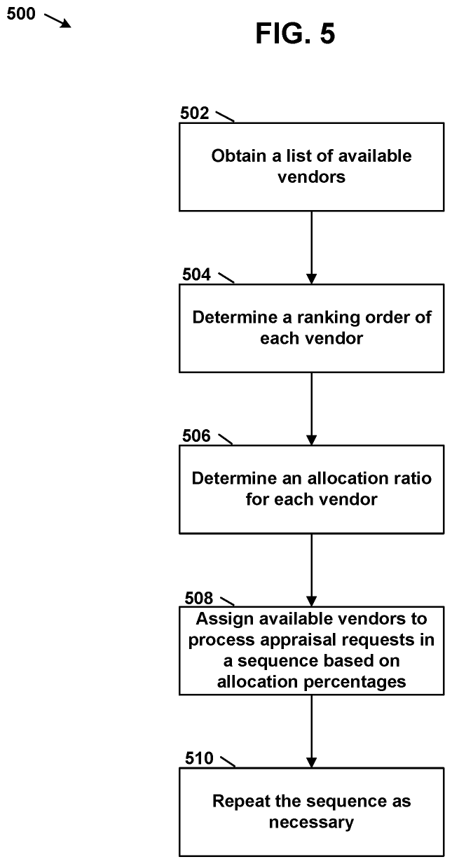

FIG. 5 shows a flowchart for an example method 500 implemented on an electronic computing device, for example on organization server computing device 104, for assigning vendors for appraisals using a fixed, repeating sequence of vendors. Each vendor is capable of performing an appraisal of real estate for lending or non-lending purposes. The vendors are typically business organizations that have an expertise in conducting appraisals.

At operation 502, organization server computing device 104 obtains a list of available vendors that can be used to perform the appraisals. The vendors can be located in different geographical areas.

At operation 504, a ranking order is determined for each vendor. The ranking order can be determined from several factors including a quality of previous appraisals, a turn-around time for completing appraisals and the geographical area in which the vendor is located. The ranking can then be determined based on a performance score for the vendor that is based on one or more of the several factors. The performance score can be determined either by vendor selection engine 106 or can be provided as an input to vendor selection engine 106 based on a business analysis of vendor performance. As stated earlier herein, the performance score can also be revised periodically, for example weekly or monthly, based on updated information for the vendors.

At operation 506, an allocation ratio is determined for each vendor. As discussed earlier herein, the allocation ratio represents an actual number of appraisals allocated to a vendor in the fixed, repeating sequence. For method 500, discussed in relation to FIG. 3, for a repeating sequence of 20 appraisals, 8 appraisals can be assigned to one vendor and 6, 3, 2, and 1 appraisals can be assigned to the other designated vendors.

At operation 508, the vendors are assigned to process appraisal requests in a sequence based on the allocation percentages and allocation ratios. FIG. 3 shows an example sequence. Operation 508 is discussed in more detail later herein.

At operation 510, the sequence established at operation 508 is repeated as necessary until all incoming appraisal requests are assigned to vendors and processed.

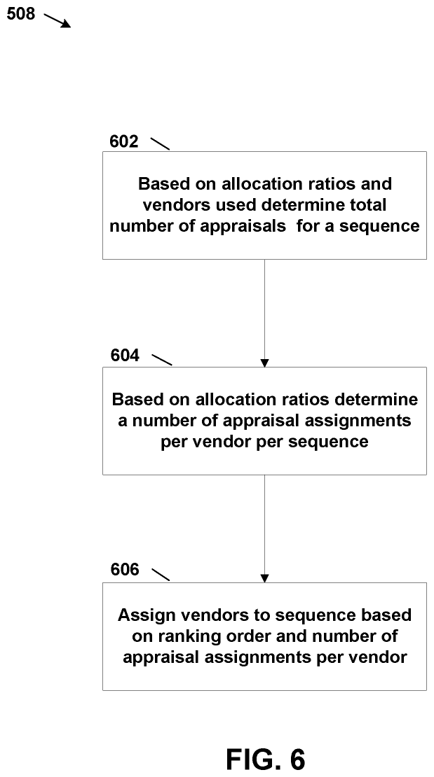

FIG. 6 shows a flowchart illustrating additional details for operation 508 of FIG. 5 to process appraisal requests in a sequence.

At operation 602, based on the number of vendors being used for a sequence and the allocation ratios for each vendor, a total number of appraisals for the sequence are calculated. For example, using the example from operation FIG. 3, based on five vendors having allocation ratios of 40%, 30%, 15%, 10% and 5%, respectively, each sequence of appraisals allocated among the five vendors can include 20 appraisals.

At operation 604, based on the allocation ratios a number of appraisal assignments are determined for each vendor for the sequence of 20 appraisals. For the example of FIG. 3, the number of appraisals for the first vendor is calculated by dividing the allocation ratio of 40% by the lowest assigned allocation percentage, in this case 5% (0.4/0.05) to arrive at 8 appraisals for the first vendor in the sequence. Similar calculations can determine 6, 3, 2 and 1 appraisals for the remaining vendors.

At operation 606, vendors are assigned to the sequence based on the ranking order for the vendors and the number of appraisal assignments per vendor. From the example shown in FIG. 4, each vendor is assigned one appraisal before any vendor is assigned a second appraisal. Remaining appraisals in the sequence are alternately assigned to vendors in a similar manner so that the number of appraisals allocated for each vendor are assigned in the sequence.

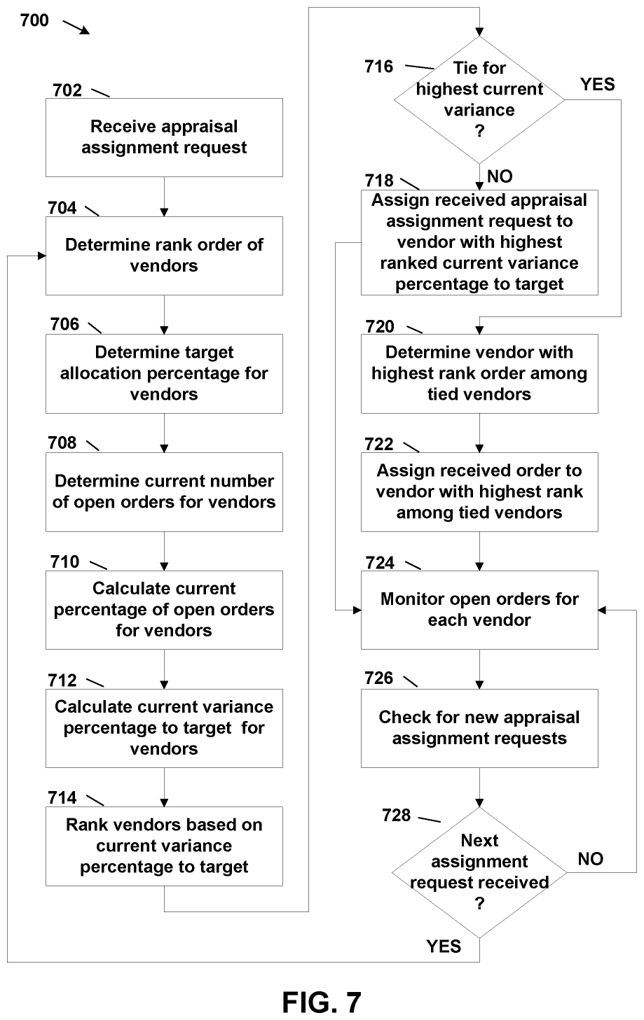

FIG. 7 shows a flowchart for an example method 700 for assigning appraisal requests to vendors using the dynamic performance evaluation method.

At operation 702, an appraisal assignment request is received at organization server computing device 104. Vendor selection engine 106 then starts a process to determine which vendor is to process the appraisal order. For the example method 700, there are five vendors (vendors A to E) that are used to process appraisals.

At operation 704, vendor selection engine 106 determines a rank order of the vendors. The rank order is based on the performance scores for the vendors, as discussed earlier herein.

At operation 706, vendor selection engine 106 determines a target allocation percentage for each vendor. As discussed earlier herein, the target allocation percentage represents a percentage of incoming appraisal orders that are designated to be allocated to a particular vendor. As discussed earlier herein, the target allocation percentage is dependent on the rank order and can be market dependent. For a given rank order, a vendor may be assigned a different target allocation percentage in different markets (e.g. cities).

At operation 708, vendor selection engine 106 determines a current number of open orders for each vendor in system 100. The current number of open orders comprises the number of orders a vendor is currently processing. This includes newly received orders and excludes orders for which appraisals have been completed by or cancelled with each vendor.

At operation 710, vendor selection engine 106 calculates a current percentage of open orders for each vendor in system 100. The current percentage of open orders for a vendor comprises the current number of open orders for the vendor divided by the sum of the current number of open orders for all vendors in system 100.

At operation 712, vendor selection engine 106 calculates a current variance percentage to target for each vendor in system 100. The current variance percentage to target for a vendor comprises the target allocation percentage for the vendor minus the current percentage of open orders for the vendor.

At operation 714, vendor selection engine 106 ranks vendors based on the current variance percentage to target for each vendor. A vendor having a highest positive current variance percentage to target is ranked first and a vendor having a highest negative current variance percentage to target is ranked last. When two or more vendors have the same current variance percentage to target, the vendor with the higher rank order is ranked higher.

At operation 716, a determination is made as to whether there is a tie for highest current variance percentage to target.

When a determination is made at operation 716 that there is not a tie for highest current variance percentage to target, at operation 718, vendor selection engine 106 assigns the received appraisal assignment request to the vendor with the highest positive ranked current variance percentage to target. Control then advances to operation 724.

When a determination is made at operation 716 that there is a tie for the highest current variance percentage to target, at operation 720, vendor selection engine 106 determines the highest rank order among tied vendors.

At operation 722, vendor selection engine 106 assigns the received appraisal assignment request to the vendor with the highest rank order among tied vendors.

At operation 724, vendor selection engine 106 monitors open orders for each vendor. When open orders for a vendor are completed or cancelled, vendor selection decreases the current number of open orders for the vendor accordingly.

At operation 726, vendor selection engine 106 checks if a new appraisal assignment request has been received.

At operation 728, when a determination is made that a new appraisal assignment request has not been received, control returns to operation 724 where vendor selection engine 106 continues to monitor open orders for each vendor.

At operation 728, when a determination is made that a new appraisal assignment request has been received, control returns to operation 704 and steps of method 700 are repeated.

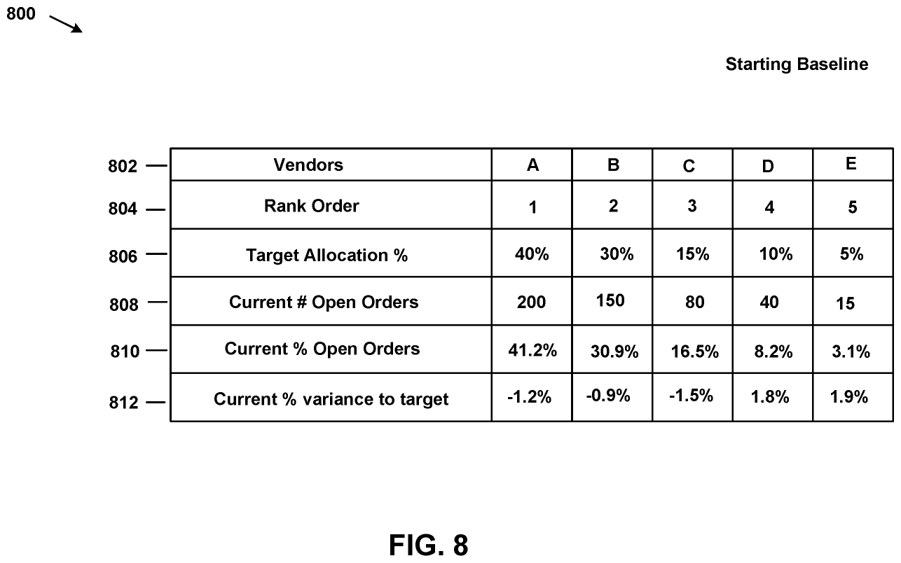

FIGS. 8-13 comprise an example that illustrates the method of assigning vendors for appraisals based on the dynamic performance evaluation of the vendors. As stated earlier herein, the dynamic performance evaluation comprises a dynamic evaluation of each of the vendor's relative capacity.

FIG. 8 shows an example table 800 for an example dynamic performance evaluation using five vendors—vendors A, B, C, D and E. The table 800 is arranged in six rows and five columns. A first row of the table 800 shows the vendors 802. A second row of the table 800 shows a rank order 804 for the vendors. A third row of the table 800 shows the target allocation % 806 for each vendor. A fourth row of the table 800 shows a current number of open orders 808. A fifth row of the table 800 shows a current percentage of open orders 810. A sixth row of the table 800 shows a current percentage variance to target 812. Table 800 represents a starting baseline for the dynamic performance evaluation.

Rank order 804 shows that vendors A-E have rank orders 1-5, respectively. The rank order 804 is determined from performance scores for vendors A-E. Vendor A has the highest performance score, vendor B has the next highest, etc. and vendor E has the lowest. As discussed earlier herein, the performance scores can either be calculated via vendor scorecard module 202 or provided as in input to vendor selection engine 106.

Target allocation % 806 shows that vendors A-E have target allocation percentages of 40%, 30%, 15% 10% and 5%, respectively. Each allocation percentage represents a percentage of incoming appraisal assignment requests that are designated to be allocated to the respective vendor.

Current #open orders 808 shows that vendors A-E have a current number of open orders of 200, 150, 80, 40, and 15, respectively. Current open orders refers to orders that are currently being processed by a vendor (i.e., assigned and neither completed nor cancelled).

Current % open orders 810 shows that vendors A-E have a current percentage of open orders of 41.2%, 30.9%, 16.5%, 8.2% and 3.1%. The current percent of open orders is equal to the current number of open orders for a vendor divided by the total number of current orders being processed by vendors A-E. The total number of current orders being processed by vendors A-E is 485, so that the current % open orders 810 are calculated as 200/485 (41.2%), 150/485 (30.9%), 80/485 (16.5%), 40/485 (8.2%) and 15/485 (3.1%).

Current % variance to target 812 shows that vendors A-E has a % variance to their target allocations of −1.2%, −0.9%, −1.5%, 1.8% and 1.9%. The current % variance to target 812 is calculated as the target allocation % 806 minus the current % open orders 810. So, for example, the current % variance to target 812 for vendor A of −1.2% equals 40%-41.2%.

For the dynamic performance evaluation process, a next incoming appraisal assignment request is assigned to a vendor having the highest positive percent variance to their target allocation percent. All vendors with negative percent variances to their target allocation percentages (for example vendors A, B and C for table 800) are ineligible to be assigned the next incoming appraisal assignment request. In addition, as discussed later herein, when two or more vendors have the highest positive percent variance to their target allocation, the vendor with the highest rank order is assigned the next incoming appraisal assignment request. Based on the current % variance to target 812 shown in FIG. 8, because vendor E has the highest positive percent variance to its target allocation (1.9%), vendor E is scheduled to receive the next appraisal assignment request.

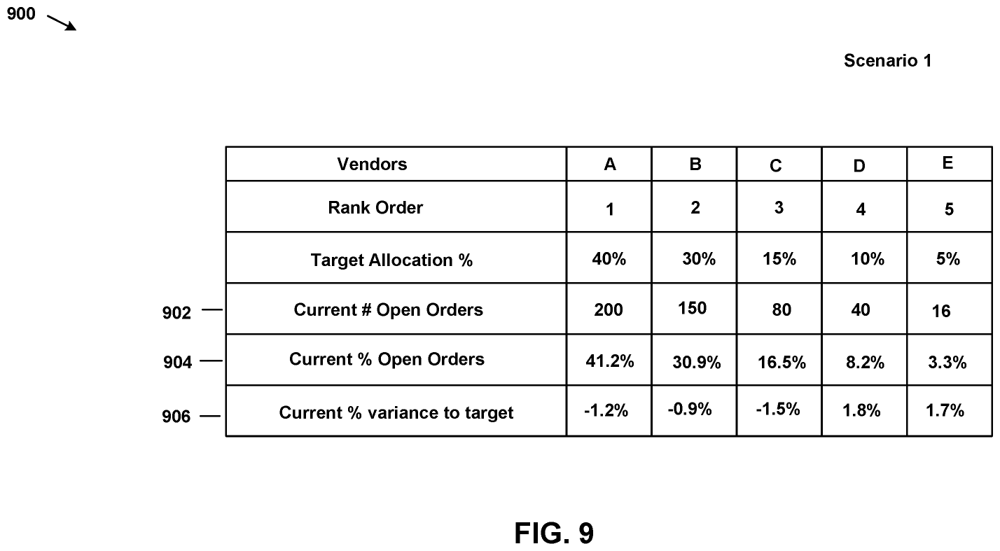

FIG. 9 shows an example table 900 for the dynamic performance evaluation method after the next appraisal assignment request is received. As can be seen in table 900, the current #open orders 902 for vendor E has increased from 15 to 16. As a result, the current % open orders 904 for vendor E has increased from 3.1% to 3.3% (16/486). In addition, the current % variance to target 906 for vendor E has decreased from 1.9% to 1.7% (5%−3.3%). Now, vendor D has a higher current % variance to target 806 than vendor E so vendor D is now scheduled to receive the next appraisal assignment request. Table 900 represents a scenario 1 of the dynamic performance evaluation.

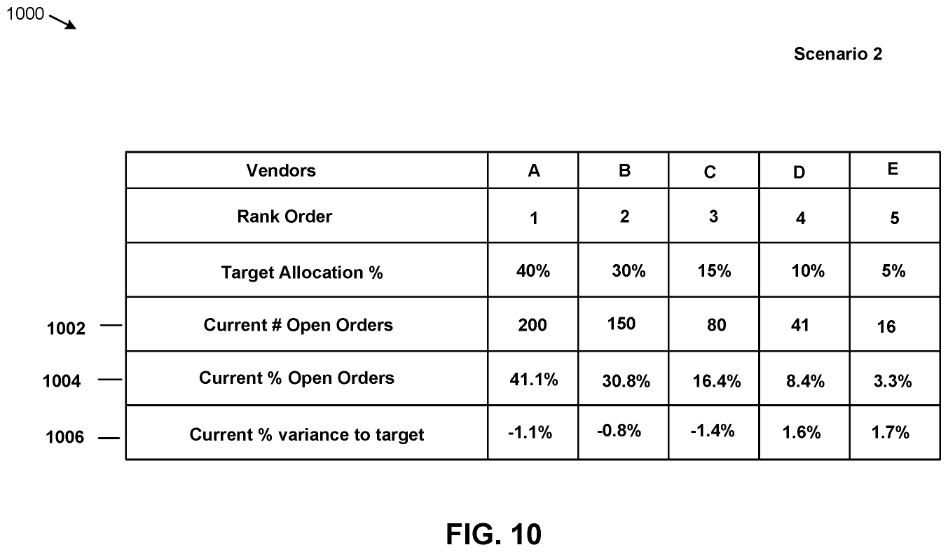

FIG. 10 shows an example table 1000 for the dynamic performance evaluation method after vendor D receives the next appraisal assignment request. As can be seen in table 1000, the current #open orders for vendor D has increased from 40 to 41. As a result the current % open orders 1004 for vendor D has increased to 8.4% from 8.2% and the current % variance to target 1006 has decreased to from 1.8% to 1.6%. Now, vendor E has a higher current % variance to target 1006 than vendor D, so vendor E is now scheduled to receive the next appraisal assignment request. Table 1000 represents a scenario 2 of the dynamic performance evaluation.

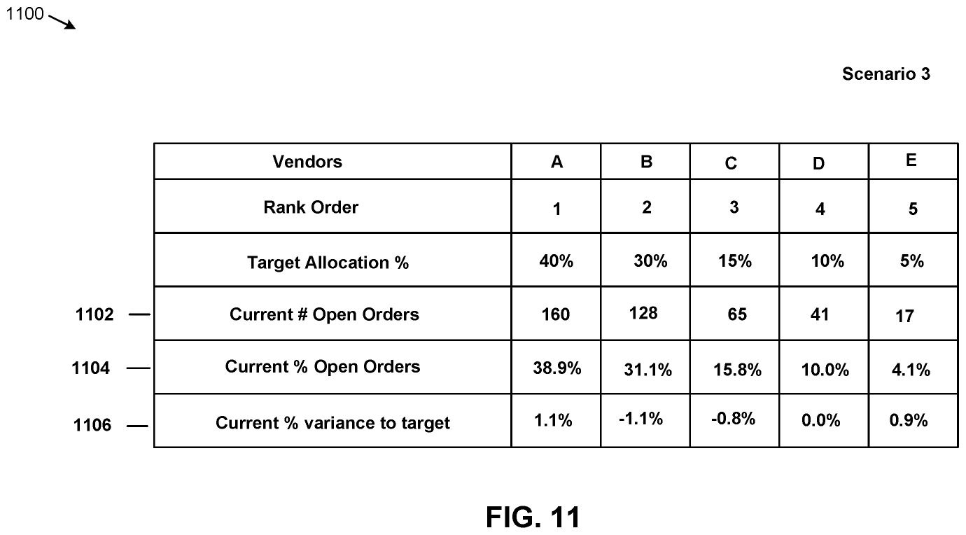

FIG. 11 shows an example table 1100 for the dynamic performance evaluation which represents a situation in which a number of current appraisal orders for vendors A, B and C are completed before the next appraisal assignment request is received, but after vendor E has already been assigned the prior appraisal assignment request in section [0089]. For the example shown in table 1100, vendor A completed 40 orders, vendor B completed 22 orders and vendor C completed 15 orders. As a result, current #orders 1102 changes to 160 (from 200), 128 (from 150) and 65 (from 80), respectively. In addition, because there are 77 fewer current orders being processed, the current % open orders 1104 and the current % variance to target 1106 changes for all vendors. Before the 77 orders were completed, vendor E was scheduled to receive the next appraisal assignment request. However, now because vendor A completed 40 orders before the next appraisal assignment request was received, the current variance % to target 1106 for vendor A changes from −1.1% to +1.1%. Now vendor A has the highest positive current variance % to target 1106 and therefore vendor A is now scheduled to receive the next appraisal assignment request. Table 13 represents a scenario 3 of the dynamic performance evaluation.

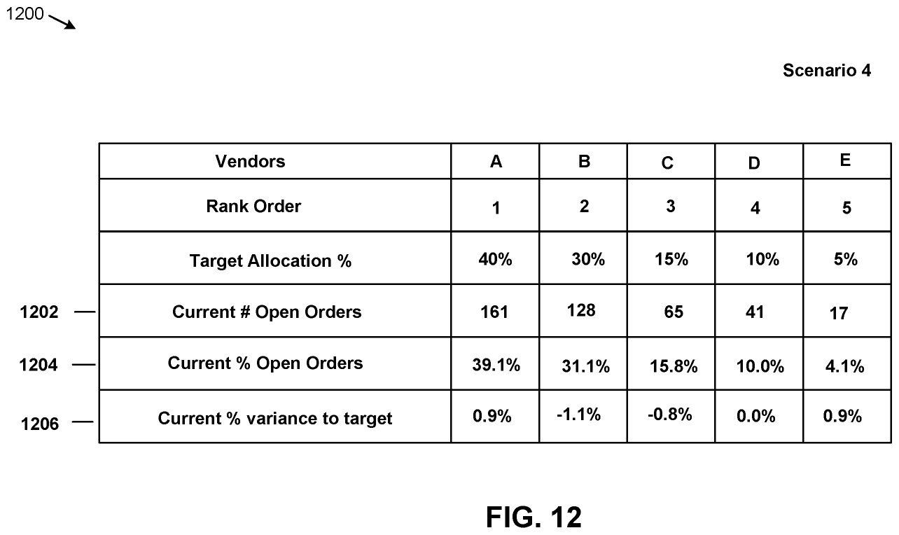

FIG. 12 shows an example table 1200 which updates table 1100 after the next appraisal assignment request is received. Because vendor A was scheduled to receive the next appraisal assignment request, the current #open orders 1202 for vendor A changes from 160 to 161. In addition, the current % open orders 1204 for vendor A changes to 39.1% and the current % variance to target 1206 for vendor A changes to 0.9%. Now the current % variance to target 1206 for vendors A and E are both at 0.9% so both have the highest positive current % variance to target 1206. Using the dynamic performance evaluation method, when ties occur for the current % variance to target 1206, the next received appraisal assignment request gets assigned to the tied vendor having the highest rank order. Because, vendor A has a higher rank order than vendor E, vendor A is scheduled to receive the next appraisal assignment request. Table 12 represents a scenario 4 of the dynamic performance evaluation.

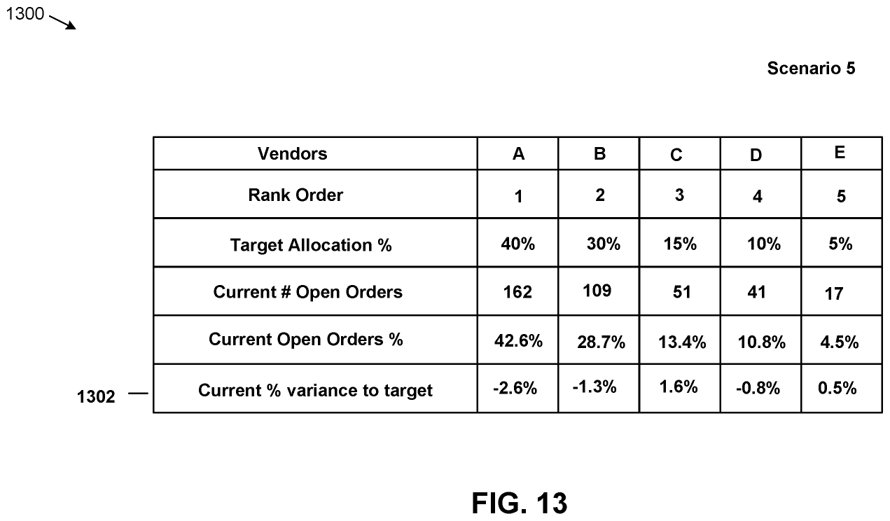

FIG. 13 shows an example table 1300 which represents an update to table 1200 after the 1 additional appraisal request has been assigned to vendor A, 19 additional orders are completed by vendor B and 14 additional orders are completed by vendor C. The additional appraisal request assigned to vendor A increases the open order total for vendor A from 161 to 162. Because vendor C completed a larger percentage of orders relative its target allocation percentage than vendors A and B, the current % variance to target 1302 for vendor C has the highest positive value (1.6%). Therefore, vendor C is scheduled to receive the next appraisal assignment request. Table 13 represents a scenario 5 of the dynamic performance evaluation.

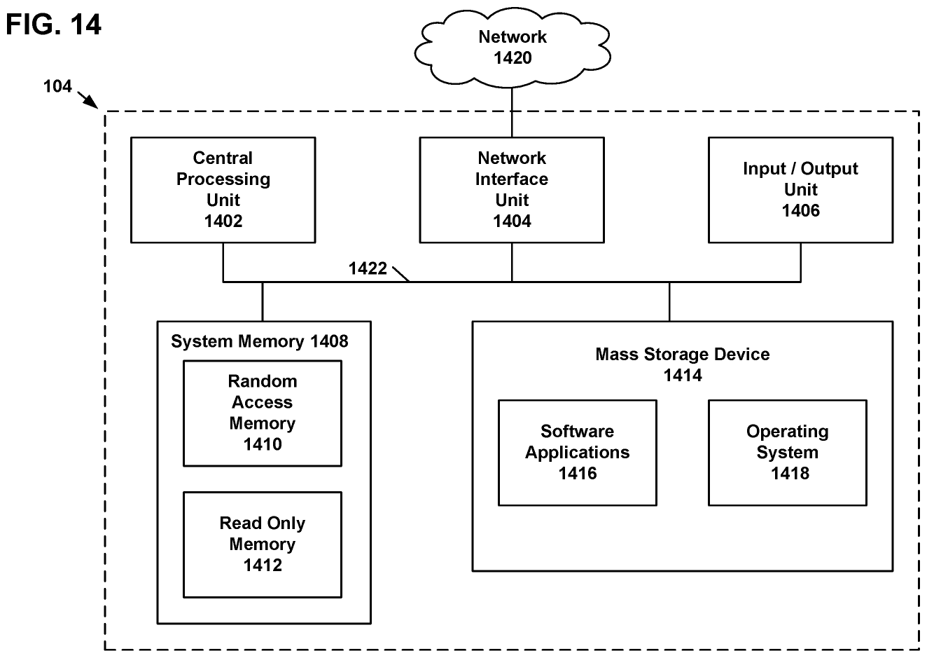

As illustrated in the example of FIG. 14, organization server computing device 104 includes at least one central processing unit (“CPU”) 1402, also referred to as a processor, a system memory 1408, and a system bus 1422 that couples the system memory 1408 to the CPU 1402. The system memory 1408 includes a random access memory (“RAM”) 1410 and a read-only memory (“ROM”) 1412. A basic input/output system that contains the basic routines that help to transfer information between elements within the organization server computing device 104, such as during startup, is stored in the ROM 1412. The organization server computing device 104 further includes a mass storage device 1414. The mass storage device 1414 is able to store software instructions and data. Some or all of the components of the organization server computing device 104 can also be included in requester electronic computing device 102 and the other computing devices described herein.

The mass storage device 1414 is connected to the CPU 1402 through a mass storage controller (not shown) connected to the system bus 1422. The mass storage device 1414 and its associated computer-readable data storage media provide non-volatile, non-transitory storage for the organization server computing device 104. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the organization server computing device 104.

According to various embodiments of the invention, the organization server computing device 104 may operate in a networked environment using logical connections to remote network devices through the network 1420, such as a wireless network, the Internet, or another type of network. The organization server computing device 104 may connect to the network 1420 through a network interface unit 1404 connected to the system bus 1422. It should be appreciated that the network interface unit 1404 may also be utilized to connect to other types of networks and remote computing systems. The organization server computing device 104 also includes an input/output controller 1406 for receiving and processing input from a number of other devices, including a touch user interface display screen, or another type of input device. Similarly, the input/output controller 1406 may provide output to a touch user interface display screen or other type of output device.

As mentioned briefly above, the mass storage device 1414 and the RAM 1410 of the organization server computing device 104 can store software instructions and data. The software instructions include an operating system 1418 suitable for controlling the operation of the organization server computing device 104. The mass storage device 1414 and/or the RAM 1410 also store software instructions and software applications 1416, that when executed by the CPU 1402, cause the organization server computing device 104 to provide the functionality of the organization server computing device 104 discussed in this document. For example, the mass storage device 1414 and/or the RAM 1410 can store software instructions that, when executed by the CPU 1402, cause the organization server computing device 104 to display received data on the display screen of the organization server computing device 104.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for allocating vendors for performing a real estate appraisal for lending or non-lending purposes, the method comprising:
receiving a first real estate appraisal request;
querying a database using a defined schema to obtain information associated with each of the vendors, with the schema defining a performance score item, and the information including a performance score from the performance score item for each of the vendors;
obtaining, at the electronic computing device, a ranking order for each of the vendors, the ranking order based at least in part on a performance evaluation of each of the vendors, with the performance evaluation being based, at least in part, on the performance score for each of the vendors;
obtaining, at the electronic computing device, an allocation percentage for each of the vendors based on the ranking order, the allocation percentage corresponding to a volume of requests for real estate appraisals that can be assigned to each respective vendor, wherein a higher allocation percentage is given to a higher ranking vendor;
performing, by the electronic computing device, a first dynamic evaluation of open real estate appraisal orders for each respective vendor, the first dynamic evaluation comprising comparing the open real estate appraisal orders to a target allocation percentage for each respective vendor;
assigning one or more vendors to perform the open real estate appraisal orders based on the first dynamic evaluation of the open real estate appraisal orders, the one or more vendors being assigned in a dynamic repeatable sequence according to an allocation ratio that defines a number of appraisals to be allocated to each of the one or more vendors in the dynamic repeatable sequence, wherein each new incoming real estate appraisal order is assigned to a first vendor having a greatest percentage variance to the target allocation percentage for each respective vendor;
receiving a request for cancelation of a canceled real estate appraisal;
upon receiving the canceled real estate appraisal, performing a second dynamic evaluation of the open real estate appraisal orders for each respective vendor;
receiving a second real estate appraisal request; and
assigning a second vendor to perform the second real estate appraisal request based on the second dynamic evaluation of the open real estate appraisal orders.

2. The method of claim 1, wherein the performance evaluation is based on a quality of the real estate appraisals performed by a vendor and a time taken to complete the real estate appraisals.

3. The method of claim 1, further comprising:
identifying a vendor with a highest allocation percentage; and
assigning the first real estate appraisal request to the vendor with the highest allocation percentage.

4. The method of claim 3, further comprising:
identifying a vendor with a next highest allocation percentage; and
assigning the second real estate appraisal request to the vendor with the next highest allocation percentage.

5-6. (canceled)

7. The method of claim 1, wherein each of the one or more vendors is assigned once in the dynamic repeatable sequence before any vendor is assigned a second time in the dynamic repeatable sequence.

8. (canceled)

9. The method of claim 1, wherein determining a current allocation percentage for each of the one or more vendors comprises:
determining a current number of open appraisal orders for a vendor;
determining a total of a current number of open appraisal orders for each of the vendors; and
dividing the current number of open appraisal orders for the vendor by the total of the current number of open appraisal orders for each of the one or more vendors.

10. The method of claim 1, further comprising: when two or more vendors have the greatest percentage variance, assigning the real estate appraisal to a vendor having a highest ranking order among the two or more vendors having the greatest percentage variance.

11. The method of claim 1, wherein a sum of the allocation percentages for each of the one or more vendors equals 100% and wherein vendors having higher ranking orders are assigned higher allocation percentages than vendors having lower ranking orders.

12. The method of claim 1, further comprising:
periodically evaluating a performance of each of the one or more vendors; and
adjusting the ranking order for each of the one or more vendors based on the performance of each of the one or more vendors.

13-20. (canceled)

21. The method of claim 1, wherein performing the first dynamic evaluation comprises calculating a current variance percentage for the first vendor, the current variance percentage comprising a difference between the target allocation percentage and a current percentage of open orders for the first vendor.

22. The method of claim 1, wherein the performance evaluation further comprises receiving status data including a number of properties currently being appraised by the first vendor, when the first real estate appraisal request was initiated, and a real estate appraisal capacity for the first vendor.

23. The method of claim 1, wherein the second vendor is a same vendor as the first vendor.

24. The method of claim 1, wherein the second vendor is a different vendor than the first vendor.
